(19) United States
(12) Patent Application Publication
(10) Pub. No.: US 2007/0147371 A1
(43) Pub. Date: Jun. 28, 2007

(54) Multicast packet video system and hardware

(75) Inventors: Hayder Radha, E. Lansing, MI (US); Mingquan Wu, Ann Arbor, MI (US); Shirish S. Karande, Lansing, MI (US)

Correspondence Address: HARNESS, DICKEY & PIERCE, P.L.C., P.O. BOX 828, BLOOMFIELD HILLS, MI, 48303, US

(73) Assignee: The Board of Trustees of Michigan State University, E. Lansing, MI (US)

(21) Appl. No.: 11/527,247

(22) Filed: Sep. 26, 2006

Related U.S. Application Data
(60) Provisional application No. 60/720,544, filed on Sep. 26, 2005.

(51) Int. Cl. H04L 12/56

(52) U.S. Cl. 370/390

(57) ABSTRACT

A multicast packet video system includes a codec placement module placing codecs in nodes of a multicasting network. In some aspects, the placement includes receiving, at a parent node of the network, feedback from its child nodes indicating a number of the child nodes unable to decode FEC blocks, and placing a codec at the parent node if the number exceeds a threshold. In alternative or additional aspects, the placement includes placing codecs in nodes of a multicasting tree of the network by recursively performing a search of a network topology T to find an optimum node c at which to place a codec in order to obtain a maximum improvement in average video-packet throughput over nodes of the tree as a result of the codec recovering lost video and parity packets and transmitting them downstream.

### CROSS-REFERENCE TO RELATED APPLICATIONS

This application claims the benefit of U.S. Provisional Application No. 60/720,544 filed on Sep. 26, 2005. The disclosure of the above application is incorporated herein by reference in its entirety for any purpose.

### FIELD

The present disclosure generally relates to channel coding systems and methods, and relates in particular to improving the reliability and efficiency (in terms of throughput) of packet video applications by optimum placement of few FEC codecs within large packet video distribution networks.

### BACKGROUND

The statements in this section merely provide background information related to the present disclosure and may not constitute prior art.

Channel coding methods have played a key role in a wide range of video applications over unreliable networks. In particular, Forward Error Correction (FEC) schemes have been proposed and used successfully for packet loss recovery over the Internet, and especially for multicast applications. Traditional multicast video applications employ FEC on an end-to-end basis between the sender and the clients. However, the reliability and efficiency of end-to-end FEC-based packet video can suffer significantly over large video distribution networks. What is needed is a new alternative for improving the reliability and efficiency (in terms of throughput) of packet video applications within large packet video distribution networks.

Yet, there exist constraints on any attempt to fulfill this need. Firstly, for many practical realtime video applications, the sender needs to transmit and adhere to a minimum source-video rate. This minimum rate, for example, can represent the bitrate of the base-layer of scalable video, or the rate of a minimum-acceptable quality non-scalable video stream. Secondly, for many applications, including ones with a large number of receivers, performing complex rate-shaping or transcoding operations may not be desirable or even feasible. Thus, the needed alternative for improving the reliability and efficiency (in terms of throughput) of packet video applications within large packet video distribution networks must maintain video quality without resorting to complex rate shaping or transcoding operations.

It is well known that the overall video quality is directly related to the effective video packet throughput that can be achieved with a given FEC channel coding rate. However, for a given FEC coding rate (e.g., based on the popular Reed-Solomon FEC method), the packet loss ratio experienced by an end-to-end FEC-based video application can become very high when the number of nodes in the distribution tree increases. This naturally leads to a reduction in video packet throughput. One alternative for improving the reliability of end-to-end FEC solution is to lower the FEC coding rate (i.e., use more redundant packets and less video packets within an FEC block). However, this approach can lead to a significant reduction in the effective source-video rate. Furthermore, and as highlighted above, the video application may need to adhere to a minimum source rate. This constraint can be expressed in terms of a rate-value k/n (i.e., the sender needs to maintain a transmission rate of k video packets over an n-packet transmission periods). Consequently, in the context of FEC channel coding, a minimum of k message (video) packets must be included in an n-packet FEC block.

### SUMMARY

A multicast packet video system includes a codec placement module placing codecs in nodes of a multicasting network. In some aspects, the placement includes receiving, at a parent node of the network, feedback from its child nodes indicating a number of the child nodes unable to decode FEC blocks, and placing a codec at the parent node if the number exceeds a threshold. In alternative or additional aspects, the placement includes placing codecs in nodes of a multicasting tree of the network by recursively performing a search of a network topology T to find an optimum node c at which to place a codec in order to obtain a maximum improvement in average video-packet throughput over nodes of the tree as a result of the codec recovering lost video and parity packets and transmitting them downstream.

The codec placement scheme according to the present disclosure is advantageous over previous codec placement schemes. For example, a distributed codec placement process can cope well with network dynamics, achieve a lower loss rate than end-to-end FEC, and consume less overhead than end-to-end FEC. Also, a centralized placement process can improve the throughput and overall reliability dramatically using a relatively small number of NEF codecs placed in (sub-) optimally selected intermediate nodes of a network. This improvement in throughput leads to dramatic improvements in the overall video quality observed at the receiving nodes, both visually and in terms of PSNR values. These significant improvements can be achieved while: (a) maintaining a desired minimum source-video coding rate to all receiver nodes: and (b) avoiding any source-video rate shaping or complex transcoding within the network.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flow diagram illustrating a multicasting network.

FIG. 2 is a set of block diagrams, wherein FIG. 2(a) illustrates a traditional, realtime video multicast with intermediate nodes performing no FEC functions in accordance with the prior art, and FIG. 2(b) illustrates a NEF codec placed in a video multicast tree in accordance with the present disclosure, such that the codec recovers lost video and parity packets and transmits them downstream.

FIG. 3 is a set of graphs, wherein FIG. 3(a) illustrates average decodable probability over all nodes in a p2p network multicast tree, and FIG. 3(b) illustrates average data packets throughput over all nodes in a p2p network multicast tree.

FIG. 4 is a set of graphs, wherein FIG. 4(a) illustrates average decodable probability over leaf nodes in a proxy-based, overlay network multicast tree, and FIG. 4(b) illustrates average data packets throughput over leaf nodes in a proxy-based, overlay network multicast tree.

FIG. 5 is a set of graphs, wherein FIG. 5(a) illustrates average psnr over all nodes in a p2p network for various test sequences with a link loss probability of 0.03, and FIG. 5(b) illustrates average psnr over leaf nodes in a proxy-based, overlay network for various test sequences with a link loss probability of 0.03.

FIG. 6 is a set of graphs, wherein FIG. 6(a) illustrates average psnr over all nodes in a p2p network for a particular test sequence at various link loss probabilities, and FIG. 6(b) illustrates average psnr over leaf nodes in a proxy-based, overlay network for a particular test sequence at various link loss probabilities.

FIG. 7 is a graph illustrating average psnr over all nodes of a p2p network for a robust encoding of a particular sequence at various link loss probabilities.

FIG. 8 is a set of plotted data and sample video frames, wherein FIG. 8(a) is a graph illustrating picture frame wise psnr for a particular sequence with robust source encoding, and FIGS. 8(b) and 8(c) provide a subjective comparison of distortion level with two codecs, and without any codecs.

FIG. 9 is a set of network diagrams, including FIGS. 9(a)-9(c), illustrating that the number of parity packets of a node requires changes as a codec sends a different number of packets.

FIG. 10 is a graphical representation illustrating average loss ratio of different groups.

FIG. 11 is a graphical representation illustrating received packets of different groups for a leaf node.

FIG. 12 is a graphical representation illustrating bandwidth overhead versus loss ratio.

### DETAILED DESCRIPTION OF THE PREFERRED EMBODIMENTS

The following description is merely exemplary in nature and is not intended to limit the present disclosure, application, or uses.

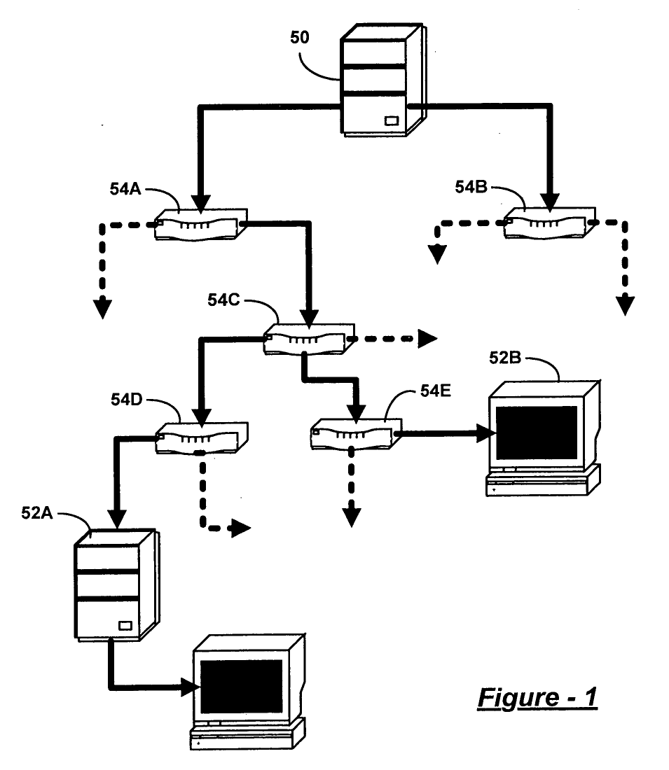

Referring to FIG. 1, improved multicasting video packet throughput is achieved in a multicasting network to accomplish transmission of a multimedia stream from a video source 50, such as a server, to receivers 52A and 52B, such as a server or personal computer, via multicast enabled routers 54A-54E. It should be readily understood that receivers can alternatively or additionally television set top boxes, personal digital assistants, cell phones, and other types of devices capable of subscribing to a multicasting session and receiving and decoding a multicast stream. Thus, the teachings of the present disclosure can be applied in television, telecommunications, and other applications where multicasting can occur.

As further explained below, under a given FEC (n,k) block constraint (i.e., a k/n coding rate constraint), improved video-packet throughput is achieved by the placement of FEC codecs within selected (optimum) locations (nodes) of the video distribution network, such as one or more selected routers 54A-54E. In particular, the impact of Network-Embedded FEC (NEF) within real-time packet video networks is analyzed and optimized. A recursively optimum scheme is developed for the placement of a small number of NEF codecs within any randomly-generated multicast video network of known (yet random) link loss rates. In essence, the proposed NEF codecs work as signal regenerators in a communication system, and hence, they can reconstruct the vast majority (and sometimes all) of the lost data packets without requiring retransmission and complex rate shaping and/or transcoding operations.

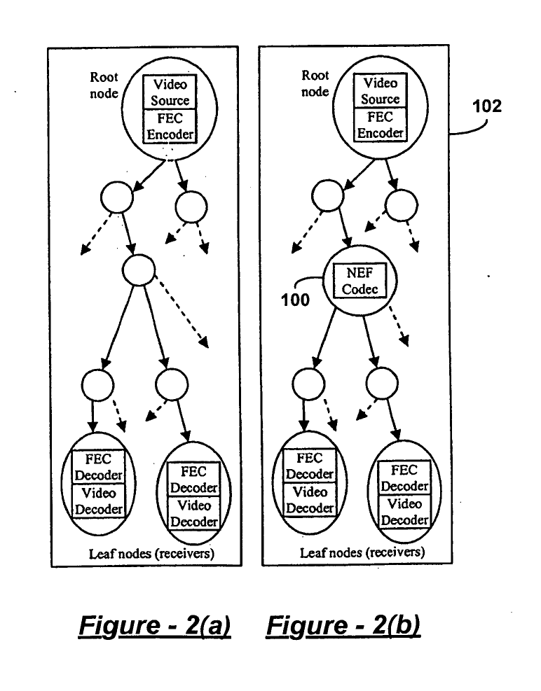

Referring to FIG. 2, an example of the proposed NEF framework includes at least one NEF codec placed at a node 100 in a multicast tree 102. The node is selected to obtain a maximum improvement in average video-packet throughput over nodes of the tree as a result of the codec recovering lost video and parity packets and transmitting them downstream. For a p2p network, the throughput is averaged over all nodes of the tree. For a proxy-based, overlay network, the throughput is averaged over only leaf nodes of the tree. Additional NEF codecs can be placed one by one at additional nodes selected in the same manner, until a target average throughput is achieved.

Emerging and new network paradigms, such as overlay and peer-to-peer (p2p) systems, can facilitate the proposed framework for placing FEC codecs within realtime video distribution networks. Accordingly, it is envisioned that the proposed NEF framework is deployed in emerging networks such as overlay and p2p multimedia multicast systems. Overlay and peer-to-peer (p2p) networks are becoming increasingly popular for the distribution of shared content over the Internet. Most of the studies conducted for these networks have focused on multicast tree building. Further, these studies assume that reliable transport and congestion control are performed by the underlying end-to-end transport protocol such as TCP. However, this assumption is not appropriate for realtime multicast applications. More importantly, the deployment of FEC within these networks for realtime multimedia applications has received very little attention (if any).

Under the two types of networks considered here, “overlay” and “p2p”, multicast functions such as membership management and data replication are promoted to the application layer. Here, to distinguish it from a p2p network, an overlay network is equivalent to a proxy-based network. In a p2p multicast network, each node in the multicast tree can also be a multicast client (receiver). In a (proxy-based) overly network, only the leaf nodes are clients. Within both networks, and at each intermediate node, data packets reach the application layer, and then get replicated and forwarded. Hence, in both cases (proxy-based or p2p), packet-loss recovery as an application level service can be placed in the intermediate nodes of the network.

Analyzing the impact of FEC on packet losses has been an active research problem that was addressed by previous efforts. In particular, previous studies analyzed the packet-loss model for FEC-enhanced multicast trees. These studies are based on the IP multicast model, in which intermediate nodes do not participate in FEC. In the following analysis, the packet-loss model of a multicast tree is studied when FEC codecs are placed in the intermediate nodes of a tree. In the following analysis, the notations put forth in Table 1 are employed.

TABLE 1

| | |
|---|---|
| T | A multicast tree with a root node r |
| \|T\| | The size (in terms of the total number of nodes) of a |
| | multicast tree T |
| T^{c} | A sub-tree rooted at some node c ∈ T but does not |
| | include the node c. |
| Tₗ^{c} | The set of leaf nodes of T^{c}. |
| \|Tₗ^{c}\| | The total number of leaf nodes of a the sub-tree T^{c} |
| P_{ν} (i) | Probability that node ν ∈ T receives exactly i packets |
| P_{ν\|ν-1} (i, j) | Probability that node ν receives i packets given that its |
| | parent ν − 1 sends j packets. |
| p | the packet loss probability between the link from |
| | ν − 1 to ν |
| (n, k) | The desired FEC block parameter pair (constraint) used |
| | by the system. n is the FEC block size, and k is the |
| | number of message (video) packets. |
| RS(n, k) | Reed Solomon code with k video packets and n − k |
| | parity packets. |

Similar to previous studies, a binomial distribution is assumed for the packet losses. For node v, if its parent v−1 sends j packets, the probability that it receives i packets is:

$${P}_{v \vert v - 1} ( i , j ) = ( \begin{matrix}j \\ i\end{matrix} ) {( 1 - p )}^{i} {P}^{j - i} \qquad ( 1 )$$

When computing the probability Pᵥ(i) that a node v receives exactly i packets, two cases are considered; firstly, the case when the parent node v−1 has no codec is considered; secondly, the case when the parent node v−1 has a NEF codec is considered. If node v's parent does not have a codec, the probability that node v receives i packets is:

$${P}_{v} ( i ) = {\sum }_{j = 1}^{n} {P}_{v - 1} ( j ) {P}_{v \vert v - 1} ( i , j ) \qquad ( 2 )$$

Note that P_{v|v-1}(i,j)=0,∀j<i. In other words, node v can receive i packets only when its parent v−1 sends at least i packets. For the root node (r) of the tree, it is defined

$${P}_{r} ( i ) = \{ \begin{matrix}00 \leq i \leq n - 1 \\ 1 i = n\end{matrix} \} \qquad ( 3 )$$

Equation (2) is a recursive function, and hence with the initial condition from (3), the probability Pᵥ(i) can be calculated for any node v in the multicast tree, that it receives exactly i packets. When a node has a codec for a RS(n,k) block, and if that node receives less than k packets and cannot decode the FEC block, it will just forward the received packets as usual; if it receives k or more packets, the node can decode the block and reconstruct the original data. It can also reproduce the lost parity packets. In fact, a codec can produce more or less than n−k parity packets if desired; however, the preferred embodiment described herein assumes that NEF codecs reconstruct the original data and reproduce the lost parity packets using the same RS(n,k) code. These packets are then multicasted downstream. The design of NEF codecs with adaptive FEC erasure codes is a problem currently under pursuit. Thus, it is envisioned that alternative embodiments of the present disclosure can be adapted to employ these codes when they become available.

Meanwhile, a node that has a NEF codec and which receives k≦j≦n packets will send n packets. If v is the immediate child of a codec, the probability that it receives i packets becomes

$${P}_{v} ( i ) = \{ \begin{matrix}{\sum }_{j = k}^{n} {P}_{v - 1} ( j ) {P}_{v \vert v - 1} ( i , n ) & k \leq i \leq n \\ {\sum }_{j = k}^{n} {P}_{v - 1} ( j ) {P}_{v \vert v - 1} ( i , n ) + & \\ {\sum }_{j = i}^{k - 1} {P}_{v - 1} ( j ) {P}_{v \vert v - 1} ( i , j ) & 0 \leq i \leq k\end{matrix} \qquad ( 4 )$$

Once a node c is assigned a NEF codec, the probability Pᵥ(i) for all v∈T^{c} will change and need to be recomputed. Equation (4) is used to calculate Pᵥ(i) for the immediate children of the codec. For nodes that are not immediate children of a codec, the calculation of Pᵥ(i) is the same as equation (2).

Here, Pᵥ^{dec} is used to represent the probability that node v can decode a RS(n,k) block:

$${P}_{v}^{dec} = {P}_{v} ( i \geq k ) = {\sum }_{i = k}^{n} {P}_{v} ( i ) \qquad ( 5 )$$

The average decodable probability of a tree T for p2p and proxy-based overlay networks is defined respectively as:

$$\begin{matrix}{P}_{avg}^{dec} = \frac{{\sum }_{v ∈ T - r} {P}_{v}^{dec}}{\vert T \vert - 1} \\ and & ( 6 ) \\ {P}_{avg - leaf}^{dec} = \frac{{\sum }_{v ∈ {T}_{l}^{r}} {P}_{v}^{dec}}{\vert {T}_{l}^{r} \vert} & ( 7 )\end{matrix}$$

If r_{d}(v) is used to represent the number of received data packets (not including the parity packets received) of a FEC block at node v, then,

$$E [ {r}_{d} ( v ) ] = {\sum }_{i = k}^{n} {kP}_{v} ( i ) + \frac{k}{n} {\sum }_{i = 0}^{k - 1} {iP}_{v} ( i ) \qquad ( 8 )$$

Here, it is assumed that for a RS(n,k) block, if a node receives i packets, on average only (k/n)i are data packets. For p2p and overlay networks, the data throughput is defined as:

$$\begin{matrix}g = \frac{{\sum }_{v ∈ T - r} E [ {r}_{d} ( v ) ]}{( \vert T \vert - 1 ) k} & ( 9 ) \\ and {g}_{leaf} = \frac{{\sum }_{v ∈ T - r} E [ {r}_{d} ( v ) ]}{\vert {T}_{l}^{r} \vert k} & ( 10 )\end{matrix}$$

Now that the techniques for analysis of optimum packet throughput for p2p and overlay networks have been described, it is possible to turn to the technique for optimum placement of network-embedded FEC codecs under rate-constraint. Accordingly, a mechanism for placing NEF codecs within a given network topology is described below.

In a large topology, identifying the optimum locations for the NEF codecs is not a trivial task. One objective is to place codecs in the intermediate nodes of a topology to maximize the average throughput. Assuming that the loss rate for each link in the topology and the number of codecs to be placed are known beforehand, the problem is similar to (but different from) the well-known P-median problem. A P-median problem is to find P locations in the network to place facilities in order to minimize the overall cost for servicing all of the nodes. Generally, in a P-median problem, the cost to serve a node is determined by the weight at the node and the distance between the node and its nearest available facility. The P-median cost has nothing to do with other facilities placed in the network. As described above, in order to calculate the decodable probability and throughput of a node, it is necessary to know the locations of the codecs that have been placed on the path that leads the node to the source, not just the immediate codec that serves the node.

Because the throughput at a node in a NEF network is impacted by all the codecs placed along the path from that node to the source (root), the dynamic programming approaches that have been used in previous network-placement problems cannot be used to solve the NEF codec placement problem. In the following description of the preferred embodiment, a greedy calculation is used to place m codecs in the multicast tree.

The greedy calculation finds the best location for the first codec, then the next best location for the second one, and so on. Once a node is selected, an FEC codec is added to regenerate any lost data or parity packets. Let T^{c}⊂T be the sub tree rooted at node c∈T not including c. If c is set as a “codec node”, only those nodes v∈T^{c} will benefit from this selection; meanwhile the “codec node” c itself will not be affected. For nodes v′∈T−T^{c}, everything remains unchanged. Let E[r_{d}(v)] and E′[r_{d}(v)] denote the average received packets for node v∈T^{c} before and after node c is set as a codec node, respectively. It is necessary to find c∈T that maximizes the following:

$${max}_{c ∈ T} [ {\sum }_{v ∈ {T}^{c}} ( {E}^{′} [ {r}_{d} ( v ) ] - E [ {r}_{d} ( v ) ] ) ] \qquad ( 15 )$$

A similar optimization objective function can be expressed for proxy-based overlay networks, except here the summation takes place over the leaf nodes only. Under the proposed greedy calculation, an exhaustive search is employed to find the best place for the first codec. After, the optimum c∈T node is found, the codec is placed at that node. The same method is used to place the next codec; this process continues until all of the m codecs are placed.

TABLE 2

| Num of | p = 3% | | p = 4% | | p = 5% | |
|---|---|---|---|---|---|---|
| Codecs | opt % | greedy % | opt % | greedy % | opt % | greedy % |
| 2 | 98.5 | 98.4 | 93.9 | 91.9 | 87.8 | 87.8 |
| 3 | 99.1 | 99.1 | 95.8 | 95.4 | 90.4 | 90.4 |

The proposed greedy calculation does not guarantee a global optimum solution for the placement of the m FEC codecs. Nevertheless, its performance has been very close to the global optimum. Table 2 shows the performance (in terms of average throughput) resulting from the placement of m=2 and 3 FEC codecs (within 100-node multicast trees) based on the greedy calculation, and compares these numbers with the throughput of the actual optimum placement under three (average) packetloss ratios (p) over the multicast trees' links. More details on the simulations employed to obtain these comparisons are presented below. It is clear from Table 2 that the greedy calculation provides an excellent set of (sub-) optimum solutions in all 6 cases covered in this example.

The throughput performance analysis presented above was applied to several random tree topologies. The popular Georgia Tech gt-itm network topology generator was used to produce a set of ten 100-node transit-stub graphs. Analysis and simulations with trees of larger sizes were also conducted. Here, the 100-node tree cases are focused upon for brevity. For each graph, Dijkstra's Shortest Path First (SPF) calculation was used to produce a tree rooted at a randomly selected node. The greedy calculation described above was used to place the NEF codecs in the multicast tree. The number of codecs was increased from 0 to 10. After each codec was placed, the improvement was calculated on average decodable probability and throughput. In addition to applying the above performance analysis on the ten 100-node trees, the network simulator2 (ns2) was used to simulate the scenario described above. The simulator was modified to allow packets to reach the UDP and application layers in the intermediate nodes. Both FEC enabled UDP agents and applications were implemented in the simulator. The analysis and simulation results were virtually identical. The analysis results are provided below.

As mentioned above, in a p2p overlay multicast network, nodes in the multicast tree are also end users, which often are placed at the edge of the Internet. Each hop in the overlay network often consists of several underlying physical hops. This implies that the loss rate of each hop can be higher than the loss rate of a backbone link in an IP multicast model. Here, results are shown when the loss rate per-link is set to 3%, 4%, and 5%. These loss rates are in accordance with previous studies. Here, the performance improvement is studied under each of these loss rates for a variety of RS codes. The results for RS (255,223), which is a popular FEC code that has both hardware as well as software implementations, are presented here.

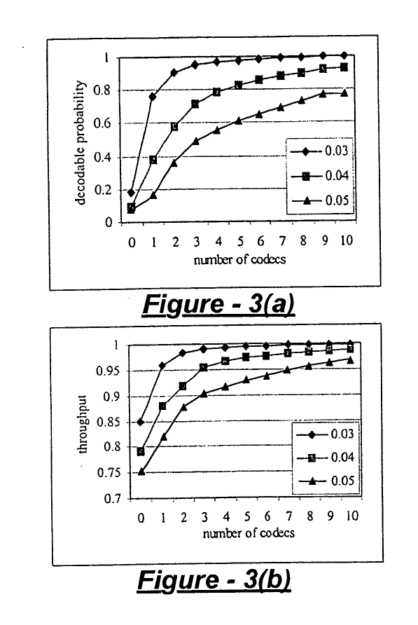

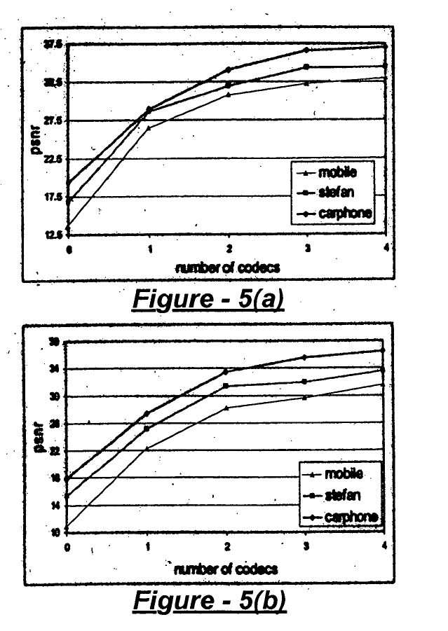

The average FEC block decodable probability and data throughput for each tree were evaluated. The results are the averages over all of the ten random trees that were analyzed. FIG. 3(a) shows the average decodable probability (over all nodes in a p2p tree) when the loss rates are set to 3%, 4% and 5%. Similar results were obtained for proxy-based overlay networks. Video simulations for both cases are shown and discussed below with reference to FIGS. 5-8. When no codecs are added, the FEC block decodable probabilities are very low for all three loss rates. For example, if the link loss ratio is 3%, the average decodable probability is just 18.6%. As the codec number increases, a dramatic increase in the decodable probability is observed. It can also be observed that a relatively small number of codecs can increase the decodable probability significantly. For a 3% per-link loss rate, the first codec increases the decodable probability from 18.6% to 76%; the first 3 codecs increase the decodable probability to above 95%. When the number of codecs increases to 10, the decodable probability reaches 99.9%; this result implies that NEF can be used to achieve a very high level of reliability while using a very high (i.e., efficient) channel-coding rate. The results for the throughput are shown in FIG. 3(b). For an average p2p node, when no codecs are added, the throughput is about 85% with per-link loss rate of 3%. The first codec raises the throughput to over 95%. With only 3 NEF codecs, the throughput increases to 99%. For a typical video application, reducing the effective packet losses from 15% (85% throughput) to less than 1% (higher than 99% throughput) naturally obtains dramatic improvements in the decoded video quality, both in terms of PSNR and visual perception.

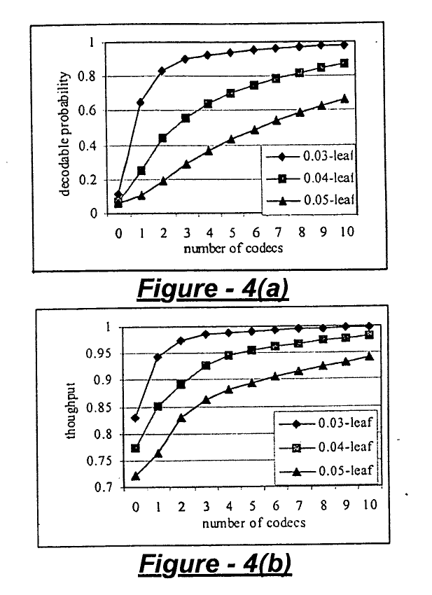

FIG. 4(a) and 4(b) show the FEC block decodable probability and packet throughput, respectively, averaged only over the leaf nodes. The leaf nodes represent the set of nodes, which receive the video packets after the maximum number of relays and thus receive the data with more losses than the overall average. It can be observed that in the absence of a NEF codec only about 10% of the FEC blocks are received without any losses. However, from FIGS. 4(a) and 4(b) it can be clearly observed that introduction of embedded FEC codecs can provide remarkable improvement in performance even for the leaf nodes.

As eluded to above, under high losses, traditional end-to-end FEC can resort to a significantly lower FEC coding rate (to lower the packet losses and achieve high reliability). However, this alternative reduces the effective source video rate significantly. In this case, NEF can be used to maintain the high reliability performance while increasing the FEC rate significantly (i.e., increasing the effective source video bitrate). Either way, NEF provides salient and dramatic improvements in the delivery of realtime video over p2p and overlay networks. Thus H.264 based video simulations are provided below to further substantiate benefits of NEF codecs.

Discussions above have concentrated on exhibiting the packet throughput improvements that can be achieved using NEF codecs. At this stage, the advantage of using NEF in terms of the quality of video service available at the receivers is clearly established. The emerging H.264/JVT video standard is used for all the video simulations that follow. All the test sequences considered below have a “cif” frame size and are encoded at a frequency of 30 frames/sec. A constant quantization size of QP=16 is employed for all the video sequences. The results presented below are a subset of the examples considered above, and thus it should be stated that the above choice of QP, frame frequency, and frame size do not compromise on the generalness of the conclusions derived on the basis of the video analysis presented here. Unless specified, no special error-resilience features are activated during the source encoding. Specifically, the “RD-optimization in presence of losses” feature is not turned on in the JVT standard unless specified. Lastly, the encoded streams are made up of video packets of size 512 bytes each.

The test sequences considered are mobile, stefan, and carphone. It should be mentioned that all the simulations are actually based on sequences that are multiple repetitions of the original test sequences. The choice of test sequences represents a diverse set of source features (e.g. stefan is a sports sequence, carphone has comparatively high temporal correlation, and mobile has multi-object motion). Thus, based on the above described encoding parameters, a lossless stream of mobile, stefan, carphone exhibits a psnr value or 33.97, 35.47, and 37.75 dB, respectively.

FIG. 5 shows the video quality of the above three sequences for a link loss probability of 0.03. It can be seen that significant improvement in video quality can be achieved by embedding codecs in the network. It can be observed that just adding 1-2 codecs can improve the performance by over 10 dB. The distortion levels continue to decrease as more codecs are introduced in the network. However, the distortion levels do not decrease by equal amounts on addition of a new codec. Thus in a practical scenario the number of codecs can be determined on the basis of the required quality of service guarantees. For example, in the simulations, although four codecs are unable to guarantee a 100% loss-less transmission, the distortion level is reduced to within 1 dB of lossless when averaged over all nodes. As the leaf nodes represent peers that receive the data after maximum impairments, naturally the distortion observed by these receivers is more than the over all average. However, compared with the quality of service received by leaf nodes in the absence of codecs, the improvement can still be termed as dramatic.

From FIG. 5 it can be observed that the stefan sequence represents in some way the averaged behavior of mobile and carphone. Thus, rather than presenting the results for all the sequences, the following discussion concentrates all the analysis on the stefan sequence.

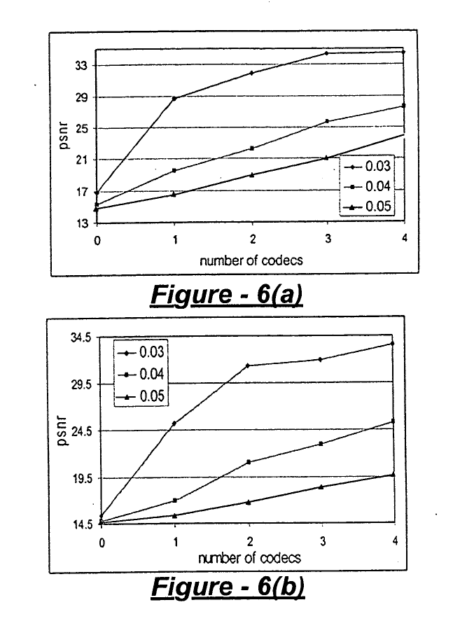

As above, the NEF performance is evaluated under different link-loss probabilities by evaluating the distortion in quality as seen by the receivers. Only results for the stefan sequence are presented. In order to describe the insight provided by FIG. 6, the following notation is considered. Let m be the number of codecs embedded in the network and let Q(m, p) be the average video quality seen by the end user for a given link-loss probability p. Thus let Q′(m,p)=Q(m,p)−Q(m−1,p) represent the utility of each incremental codec. It can be observed that Q′(m,p) is a monotonically decreasing function with respect to m. In other words, the quality improvement on account of adding a new codec decreases as the number of already embedded codecs increase. Moreover, it should be noted from FIG. 6 that the distortion decrement that can be achieved by a small number of codecs is more when the link-loss probability is low, e.g. Q′(1,0.03)>Q′(1,0.04) for all nodes. However, as n increase, the distortion improvement for low link-loss probability saturates, but for high link-loss probabilities performance improvement on account of adding a new codec can still be substantial (e.g., Q′(4,0.03)<Q′(4,0.04)). Thus it can be concluded that utility of NEF even in very poor channel conditions can also be significant. However, as the channel conditions deteriorate the number of codecs has to be increased in order to maintain the quality of service.

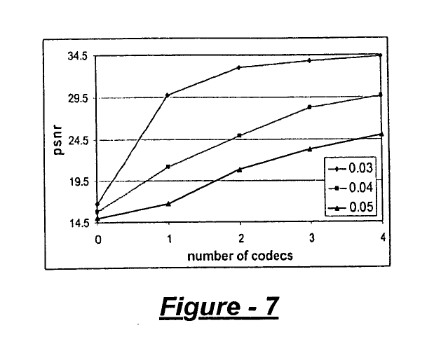

It could be argued that if a robust enough source code is used, then the advantage of using NEF codecs might not be significant. However, the results show that this is not at all the case. A robust encoding of the stefan sequence is used to present the results. The H.264 RD optimization feature is used to optimize the source encoding for a loss rate of 30%. The rest of the simulation setup is maintained as before. Observing FIG. 7, it can be seen that NEF codecs continue to provide improvement over 10-15 dbs but, comparing FIG. 7 with FIG. 6, it should be observed that the improvements are not as dramatic as in the case of a non-robust source encoding.

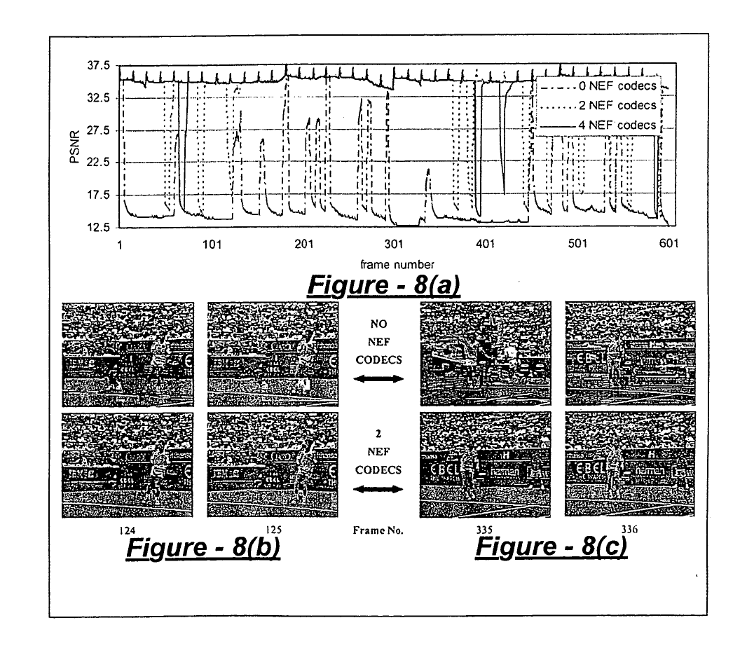

As the relative improvement of the NEF scheme for the robust source encoding is less than that for non-robust encoding, the “robust” stefan sequence is purposefully chosen to present the subjective results. This represents a minimal distortion reduction (i.e., minimum advantage) that can be achieved by using NEF. FIG. 8(a) is a temporal video quality plot. When losses are incurred, the distortion in a video sequence suddenly increases. This sudden increase in distortion is represented by the downward spikes in FIG. 8(a). It can be seen that as the number of codecs are increased the frequency of these downwards spikes are decreased. In fact, the overall video quality in absence of video codecs is so low, that upward spikes or quality improvements are obtained on account of intra-refresh or some other error resilience feature, instead of downward spikes.

FIGS. 8(b) and FIG. 8c) compare actual video frames to facilitate a clear subjective comparison. It is important to note that the choice of frames is not all biased in favor of NEF (in fact it is slightly biased against NEF). Again, it can be clearly seen that the block distortion level or loss of motion prediction is very high in the absence of codecs. As error concealment features use data from previous frames to reduce block distortion, the primary artifact causing loss in video quality is not block-distortion; in fact, the primary artifact is jerkiness. The video was observed to be very discontinuous in absence of codecs, and this discontinuity decreases as codecs are increased. As psnr is primarily determined by block distortions, it should be appreciated that improvement in video quality in terms of the viewing experience is even greater than predicted by the psnr plots.

It should be readily understood that a new approach for improving the reliability and throughput of packet video by optimum placement of FEC codecs within large packet video distribution networks is explored above. An optimization calculation for the placement of FEC codecs within selected nodes of random packet-video networks is also developed. The preceding discussion further demonstrates that this approach provides significant improvements in video quality, both visually and in terms of PSNR values. The proposed approach has been motivated by: (a) the need to adhere to a minimum source-video rate constraint that many practical video application require; (b) the need for avoiding complex transcoding operations that may not be feasible over large video networks; and (c) exploiting new and merging peer-to-peer and overlay networks that facilitate the proposed framework for placing FEC codecs within realtime video distribution networks.

Turning our attention now to alternative or additional embodiments, Peer-to-peer systems are becoming increasingly popular in applications such as object lookup, content distribution and event notification. Most of the research efforts in this area are focused on distribution of content to a group of users by employing a store and forward reliable transmission on the top of the underlying unicast transport protocol such as TCP. For realtime applications, however, TCP is not a viable option. As TCP prefers reliable rather than on-time delivery, a detected packet loss may intrigue a significant decrease in data rate, which may cause the quality of the realtime service drop to an unacceptable level.

Realtime applications often can tolerate limited packet losses but have strict time delay constraints, using automatic repeat request (ARQ) for error recovery may add large round trip time (RTT) delay to recover a lost packet; also using ARQ in multicast applications causes the well-known feedback implosion problem; this makes FEC more appealing for many multicast applications (realtime and non-realtime). For realtime multicast applications that support a large number of receivers, end-to-end FEC may require a significant number of redundant (parity) packets to provide reasonable level of protection and reliability. This leads to a very low channel-coding rate, which in turns lead to very low source (e.g., video) rate.

In the embodiment discussed above with respect to FIGS. 1-8, the deployment of Network-Embedded FEC (NEF) for content distribution over peer-to-peer networks is advocated. In NEF, FEC encoders and decoders (codecs) are placed in the intermediate nodes of a multicast distribution network. These FEC codecs can detect and recover lost packets in FEC blocks at earlier stages before these blocks reach deeper nodes in the multicast tree or final leaf nodes, thus significantly decreasing the probability of decoding failure and improving the message throughput. As packet losses in the Internet are often correlated and occur in bursts, the impact of packet loss correlation on the performance of NEF was analyzed and it was concluded that NEF outperforms end-to-end FEC under packet loss correlation.

In the embodiment discussed above with reference to FIGS. 1-8, a centralized codec placement process was used to analyze and evaluate the performance of NEF, where a greedy process was implemented to place a specified number of codecs in a multicast distribution network. In the centralized codec placement process, it was assumed assume that the network topology and the loss rate on each branch of the network are known or can be accurately estimated. In reality, it is very difficult to know the loss rate of each branch on the multicast tree beforehand. In particular, the loss rates could change rather frequently according to network conditions and cross traffics. Furthermore, the topology of a multicast session usually varies over time as users join and leave the session randomly. Moreover, it does not scale to run a centralized process for a large network.

In a large network, it is desirable to limit the number of codecs in a multicast session even if every node is willing to act as codec; too many codecs may cause longer delay penalties and may transmit too many unnecessary packets into the network. In order for a node i to act as a codec, it is required that: first, on average, the node i must be able to decode FEC blocks successfully; second, the number of children (of node i) that require extra parity packets must be above a certain threshold.

In the distributed process, each node i keeps a link list of child_info data structure; each child_info data structure keeps the information associated with each of its immediate children. The child_info has the following data members:
req_parity_imm indicates the parity packets required by the child from its immediate codec upstream;
req_children indicates the number of nodes in the sub-tree rooted at the node that, on average, can not decode FEC blocks if it does not receive parity packets produced by its immediate codec upstream.

Immediate codec upstream means the closest codec to the node on the path that leads the node to the source. In our distributed process, a node keeps a record for each codec upstream from this node. When a node receives a parity packet produced by a codec, it records its IP address and the hop-count from the codec to itself, so the node can tell which codec is its immediate codec. Each node also keeps the following records about itself:
avg_recv, an estimate for the average received packets per FEC block;
avg_recv_imm, an estimate of the average received packets per FEC block without counting the parity packets it receives from its immediate codec upstream.

The packets that a node receives (avg_recv) consist of message and parity packets, which are sent by the source, and parity packets that are sent by one or more codecs upstream. The estimate of the average received packets can be used by a node to decide if it is a qualified codec candidate. This estimation, however, can not be used to calculate the number of extra parity packets it requires from a codec in order to decode a FEC block.

Assume that a RS(n,k) Reed Solomon FEC code is being used and avg_recvᵢ is the estimate of the average received packets per FEC blocks of node i. When there are no codecs upstream, k−avg_recvᵢ is the average number of extra parity packets needed for node i to decode an FEC block. If there are already one or more codecs upstream, then k−avg_recvᵢ represents the incremental requirement based on the number of parity packets those codecs have already sent and the changed network conditions.

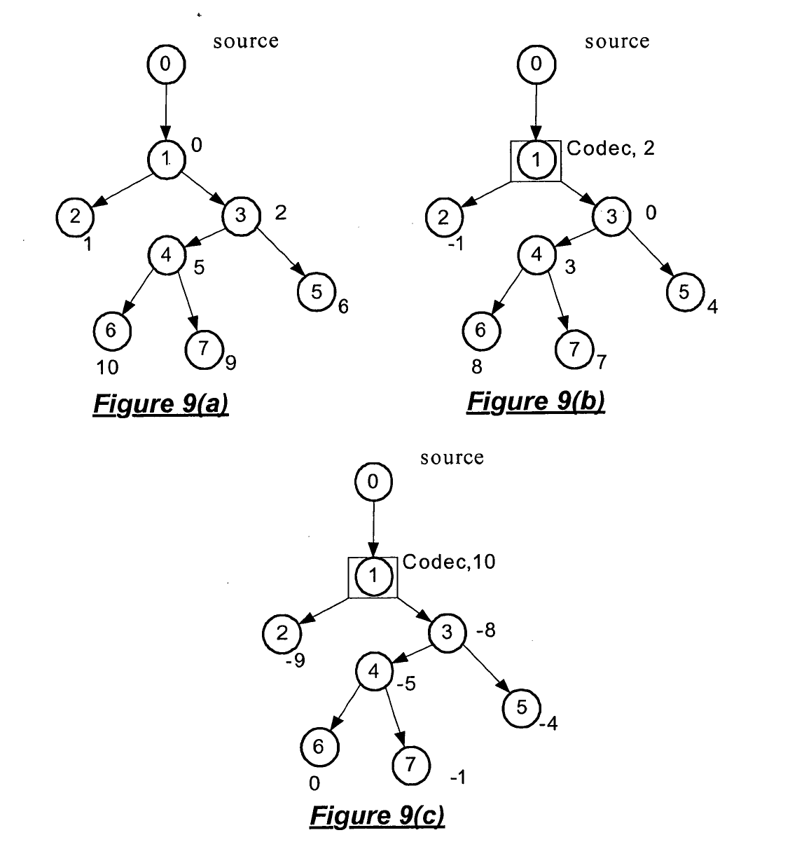

FIG. 9 shows an example with respect to a network of nodes 0-7. In FIG. 9(a), there is no codec in the multicast tree, each number outside the circle is the number of parity packets that node requires; in this case, node 3 requires 2 packets and node 6 requires 10 packets, etc. In FIG. 9(b), node 1 receives feedbacks from node 2 and 3 and becomes a codec. Node 1 then produces and transmits 2 extra parity packets downstream. If these parity packets do not suffer from being lost and the network condition does not change, then the average received packets for nodes downstream from node 1 will increase by 2, and k−avg_recvᵢ will decrease by 2. In FIG. 9(b), the number outside each circle is updated to reflect this change. In this case, node 3 requires 0 parity packets and node 6 requires 8 parity packets. FIG. 9(c) reflects the updated number when node 1 receives the first feedback message from node 6 and produces and sends 10 extra parity packets downstream.

Let us consider a comparison of FIG. 9(a) and FIG. 9(b), using node 6 as an example. When k−avg_recv is changed from 10 to 8, node 6 does not know whether this change is caused by a codec upstream sending extra parity packets or caused by the improved network condition. Let us also consider a comparison of FIG. 9(b) and FIG. 9(c), k−avg_recv of node 6 is changed from 8 to 0; again, node 6 does not know if the change is caused by a codec sending a different number of parity packets or by the dynamic network condition—in a distributed environment, a node in general does not know how many parity packet a codec upstream produces and transmits. In either case, it is difficult for node 6's parent, node 4, to update as exactly how many parity packets node 6 is requiring.

In order to circumvent this problem, each node is required to evaluate another estimate: the average received packets per FEC block without counting the parity packets it receives from its immediate codec upstream. If avg_recv_imm is used to represent this estimate, then k−avg_recv_imm represents the number of parity packet a node requires from its immediate codec upstream. In the above example, if the network conditions do not change, then k−avg_recv_imm of node 6 will remain unchanged (as 10) no matter how many parity packets the codec (node 1) produces and transmits. However, if the network conditions are changed, k−avg_recv_imm will be changed to reflect the differences.

In FIG. 9(b), the immediate codec upstream of node 6 is node 1. Here, it can be seen that once node 1 becomes a codec, node 3 can now receive enough packets to become a codec candidate. Node 3 has 4 children that can not decode FEC blocks, if this number passes the predefined threshold, then node 3 becomes a codec. Now the immediate codec upstream of node 6 becomes node 3. After node 3 becomes a codec, it will still send feedback to its parent, node 1; the number of parity packets it requires is not the biggest number required among its children (in this case, 10), but the number of parity packets itself requires (in this case, 2); the number of children that can not decode FEC blocks, however, is the same as that when node 3 is not a codec (in this case, it is 5, including node 3 itself). Node 3, as a codec, will forward all packets transmitted from node 1 to its children, including parity packets produced by node 1. Node 6, now have two codecs upstream, will only estimate the number of parity packets it requires from its nearest codec, node 3. If the network condition remains the same as that when only node 1 is a codec, the number of parity packets node 6 requires from node 3 is 8.

In the following description of the distributed process, the node number is used as an index to reference the above parameters of a particular node. For example, avg_recvᵢ represents the average received packets per FEC block of node i.

Initially, there is no codec in the multicast session. Each node records its average received packets per block in avg_recv. At this point, avg_recv_imm and avg_recv are equal. The number of parity packets each node requires from its immediate codec upstream is (k−avg_recv_imm). The parity packets sent by a codec, however, are suffered from losses. Assuming the loss rate from the nearest codec to node i is rᵢ, then the number of parity packets node i requires may adjust to:
avg_reqᵢ=(k−avg_recv_immᵢ)*(1+rᵢ)

Each parity packet sent by a codec have a sequential number and a group tag, this can help a node to estimate rᵢ. Also there is variation for the received packets per FEC block; this is especially true when loss occurs in bursts. Assuming the variation that node i receives avg_recv_immᵢ packets is avg_devᵢ, then the number of parity packets node i requires is adjusted to
avg_reqᵢ=(k−avg_recv_immᵢ)×(1+rᵢ)+avg_devᵢ
The estimations of the above referred parameters are listed below:
avg_recv(K+1)=(1−g)×avg_recv(K)+g×recv(K+1)
avg_recv_imm(K+1)=(1−g)×avg_recv_imm(K)+g×recv_imm(K+1)
avg_err(K+1)=recv_imm(K+1)−avg_recv_imm(K)
avg_dev(K+1)=(1−h)×avg_dev(K)+h×avg_err(K+1)

Here, avg_recv (K) represents the average received packets per FEC block up to the time when a node receives the Kth FEC block; recv (K+1) represents the packets received by a node for block K+1, recv_imm (K+1) represents the packets received by a node for block K+1 without counting the parity packets sent by the immediate codec upstream of the node. In our estimation, g is set to 0.1 and h is set to 0.2.

Let max_reqᵢ be the largest number of parity packets required by the node itself and its immediate children; sum_childrenᵢ be the total number of nodes in the subtree rooted at this node(including itself) that, on average, can not decode FEC blocks if they do not receive parity packets produced by its immediate codec upstream. If node i is a leaf node, then max_reqᵢ=avg_reqᵢ; if avg_recv_immᵢ<k, then sum_childrenᵢ₌1, otherwise, sum_childrenᵢ₌0. If node i is an intermediate node, max_reqᵢ is initialized to avg_reqᵢ; if avg_recv_immᵢ<k, then sum_childrenᵢ is initialized to 1, otherwise, it is initialized to 0. For the intermediate nodes, max_req and sum_children will be updated when it receives feedback from its children.

Each node sends feedback to its parent periodically. In our process, a node will send feedback each time a new FEC block is received. As an example, if RS(255,239) code is used, then a node will send a feedback message for every 255 packets it receives.

In the feedback message, node i reports to its parent max_reqᵢ and sum_childrenᵢ. As this information is passed from the leaf nodes toward the root of the multicast tree, eventually, each node will know the largest number of parity packets required among the nodes that belong to the subtree rooted at this node; each node will also know the total number of nodes in this subtree that, on average, can not decode FEC blocks if they do not receive extra parity packets from the immediate codec upstream this node.

Procedure 1 describes the action taken by a node when it sends a feedback message. Here, a codec will also send feedback; however it will only send to its parent the number of parity packets it requires itself, not the largest number required by its children.

Procedure 1

```
Procedure Send_feedback
Node i send feedback its parent node j
IF node i is a leaf node THEN
    max_reqᵢ = avg_reqᵢ
    IF avg_recv_immᵢ < k THEN
      sum_childrenᵢ = 1
    ELSE IF avg_recv_immᵢ ≧ k THEN
      sum_{'}childrenᵢ = 0
    END IF
END IF
IF node i is a intermediate node THEN
  ${max}_{—} {req}_{i} = {max}_{m ε {C}_{i}} ( {child}_{—} {info}_{m} \to {req}_{—} parity , {avg}_{—} {req}_{i} )$
  IF avg_recv_immᵢ < k THEN
    ${sum}_{—} {children}_{i} = 1 + {\sum }_{m ε {C}_{i}} ( {child}_{—} {info}_{m} \to {req}_{—} children )$
  ELSE IF avg_recv_immᵢ ≧ k THEN
    ${sum}_{—} {children}_{i} = {\sum }_{m ε {C}_{i}} ( {child}_{—} {info}_{m} \to {req}_{—} children )$
  END IF
END IF
IF node i is codec THEN
    Send max_reqᵢ = avg_reqᵢ
END IF
    Send max_reqᵢ, sum_childrenᵢ to node j
END Send_feedback
```

### Procedure 1

Assume node j is node i's parent. When node j receives a feedback from node i, node j will first update node i's information in child_info₁, then it will make a decision to see if it can act as a codec. If avg_recvj≧k and the sum of nodes among its children that can not decode FEC blocks is bigger than a certain threshold, say thresh_children (the threshold sets a limit on the number of codecs), then the node can make a decision to become a codec. Procedure 2 and Procedure 3 summarize the action taken by node j when it receives feedback from node i.

Procedure 2

```
Procedure Receive_Feedback
  Node j receive feedback from node i
  child_infoᵢ →req_children = sum_childrenᵢ
  child_infoᵢ →req_parity = max_reqᵢ
  Call Procedure Decision_making
End Receive_Feedback
```

### Procedure 2

Procedure 3

```
Procedure Decision_making
  Node j make a decision whether it should be a codec
  ${sum}_{—} {children}_{j} = {\sum }_{m ε {C}_{j}} ( {child}_{—} {info}_{m} \to {req}_{—} children )$
  ${req}_{—} {max}_{j} = {max}_{m ε {C}_{j}} ( {child}_{—} {info}_{m} \to {req}_{—} parity )$
  IF node j not a codec THEN
    IF avg_recvⱼ ≧ k
      and sum_childrenⱼ ≧ thresh_children
      and req_maxⱼ > 0 THEN
        Set node j a codec
    END IF
  ELSE IF node j is a codec THEN
    IF avg_recvⱼ < k
      or sum_childrenⱼ < thresh_children
      or req_maxⱼ ≦ 0 THEN
        Set node j not a codec
    END IF
  END IF
End Decision_making
```

### Procedure 3

Once a node becomes a codec, if it can decode an FEC block, it can reconstruct the original FEC block; at the same time, it will produce the largest number of parity packets required by its children (the maximum among child_info→req_parity_imm) and forward to each child the number of parity packets they have required (child_info→req_parity_imm). Each node along the forwarding path of the multicast tree also knows the largest number of parity packets required by each of its children (child_info→req_parity_imm), so the node does not necessarily forward all the parity packets it receives to all of its children, but only forward the number of parity packets each child has requested; this way, the transmission overhead is decreased.

The process runs on top of an overlay multicast routing protocol. The random join and leave of nodes to a multicast session will not affect the performance of the process. For example, when a node first joins the multicast session, its parent will allocate a child_info data structure for this node. The node will estimate its avg_recv and avg_recv_imm according to whether or not there are codecs upstream. When the node sends feedback to its parents, the parent will update the information stored in child_info for this node.

If a leaf node leaves a session, the parent of this node will detect this leave (by the routing protocol or other mechanism) and will delete the child_info data structure for this child. If this child has been the node that requested the biggest number of parity packets among all the children, the parent will then select the biggest number of parity packets required among all its other children and send a feedback to its parent.

If an intermediate node leaves a multicast session, the behavior of the parent of this node will be the same as that when a leaf node leaves a session. The children of this node will reset their estimation of avg_recv and avg_recv_imm. The overlay multicast routing protocol will find new parents for the children. The parents will allocate child_info data structures to these children as if they are newly joined nodes, and the children will restart their estimation of avg_recv and avg_recv_imm once they receive packets from their new parents.

The performance of the distributed NEF codec placement process is evaluated on an overlay network that has a de Bruijn topology. A de Bruijn graph can be built with a degree of 3 and a diameter of 4, with a total of 81 nodes. To construct a multicast tree, a random node can be first selected as a source, and each node then routed along the shortest path to the source, until it reaches a node already in the multicast tree. For evaluation purposes, the distributed codec placement can be implemented in network simulator ns2.

The channel code used is RS(255,239); the packet loss rate on each branch is uniformly distributed between 1% and 3%. The packet loss correlation p is set to 0.5. The thresh_children in the distributed process is set to 3.

When a node joins a multicast session, it is appended to the multicast tree as a leaf node. When a leaf node leaves the multicast session, its parent just delete its states and update the corresponding parameters. These cases do not have an immediate impact on the performance of NEF. When an intermediate node leaves a multicast session, however, all its children need to find their new parents. In our simulation, when an intermediate node leaves a multicast session, it will send a message to its parent, so the parent will no longer forward packets to this node, and delete the states kept for this node. This node will also send a leave message to all of its children. All its children then will run the join procedure to reconnect to the multicast tree.

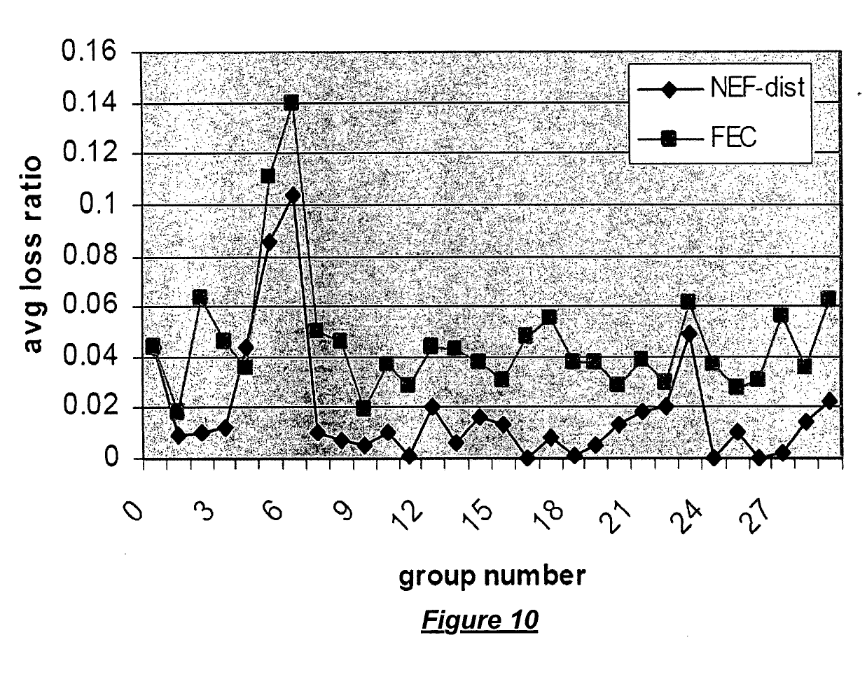

FIG. 10 shows the average loss ratio of all the clients in the multicast session of NEF and traditional (end-to-end) FEC for different FEC blocks (or FEC groups as indicated by the x-axis label). It can be seen that average loss ratio for NEF is always smaller (mostly significantly smaller) than that of FEC. Between block 5 and 6, an intermediate node leaves the multicast session, all its children are affected, and it can be observed that there is a spike on the average loss ratio. Overall, traditional FEC losses vary between 4% and 6%, whereas the codec distributed process mostly maintains lower than 2% in average packet losses.

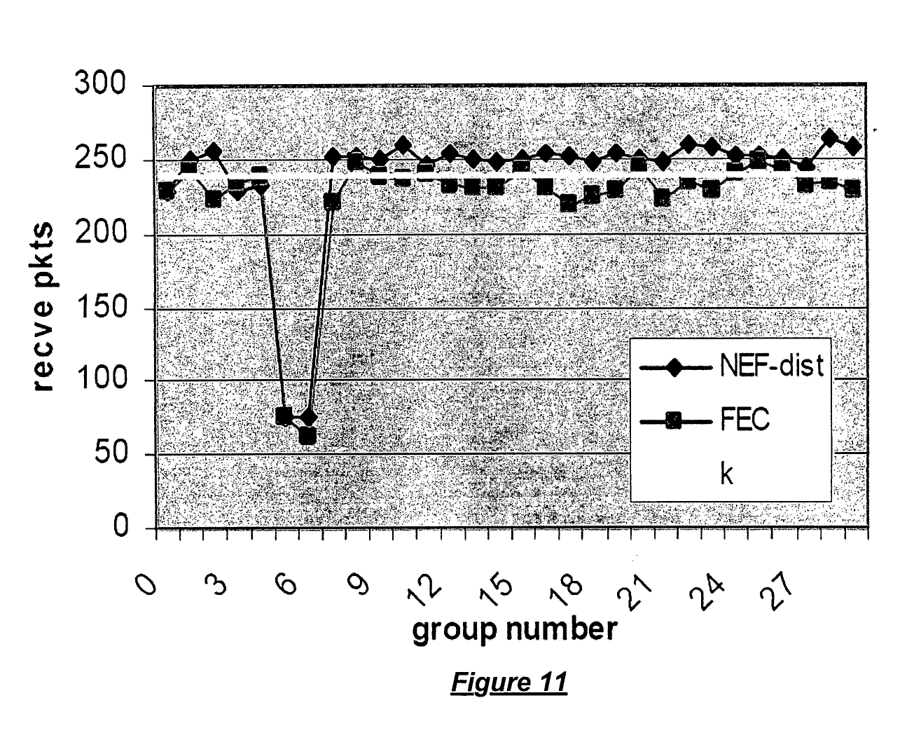

FIG. 11 plots the received packets of a leaf node for different groups. Again, it can be observed that the drop in the received packets when an intermediate node leaves the multicast session. It can be seen that when running NEF, the receiver can receive more than k packets for most of the blocks, while for end-to-end FEC, the receiver receives less than k packets for many blocks.

Despite the clear superior performance for NEF under the proposed distributed process, NEF codecs send extra packets into the network, and hence it is important to characterize the bandwidth overhead of NEF and end-to-end FEC. Here, the bandwidth overhead is measured in terms of the cost for each message packet received. The cost of a message packet is the product of the average number of packets transmitted per message packet and the average number of links (hops) these packets traversed. The bandwidth overheads of NEF and FEC are the differences between their bandwidth costs and the ideal bandwidth cost, which is measured when there is no loss in the network.

The performance of the distributed codec placement process is compared with the centralized process and end-to-end FEC. In this case, the join and leave scenario is not simulated. The three schemes are run on the same multicast tree. The FEC codes used are Reed Solomon codes with k=239 and n is increased from 245 to 275 in steps of 5. For the centralized codec placement process, for each FEC code used, the number of codecs is changed from 1 to 5. In the distributed codec placement process, the condition parameter thresh_children is set to 1, 3 and 7 respectively. In the centralized and distributed codec placement processs, if there are multiple implementations that achieve the same average loss ratio, the implementation that has the minimum overhead is selected.

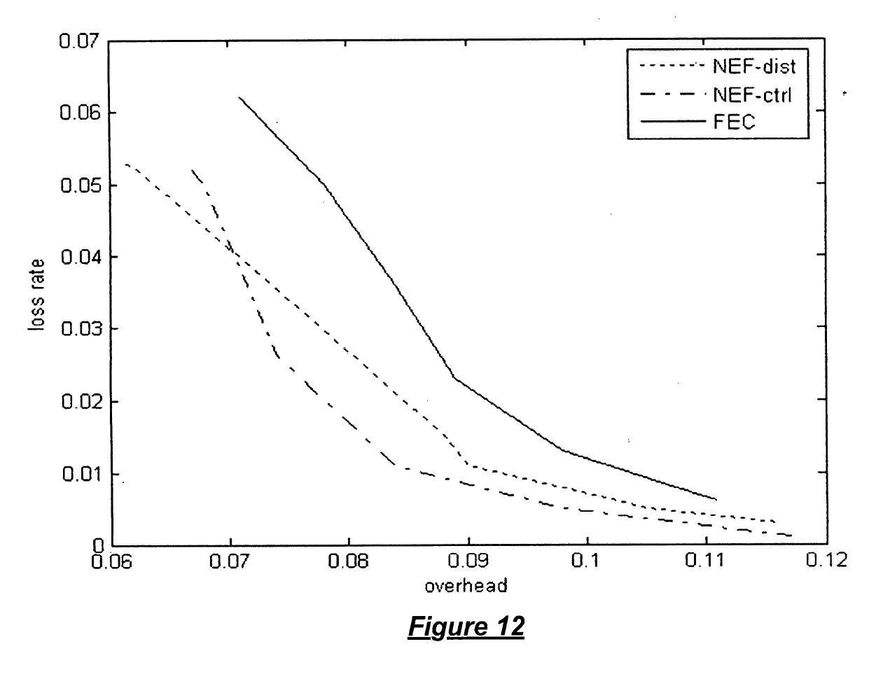

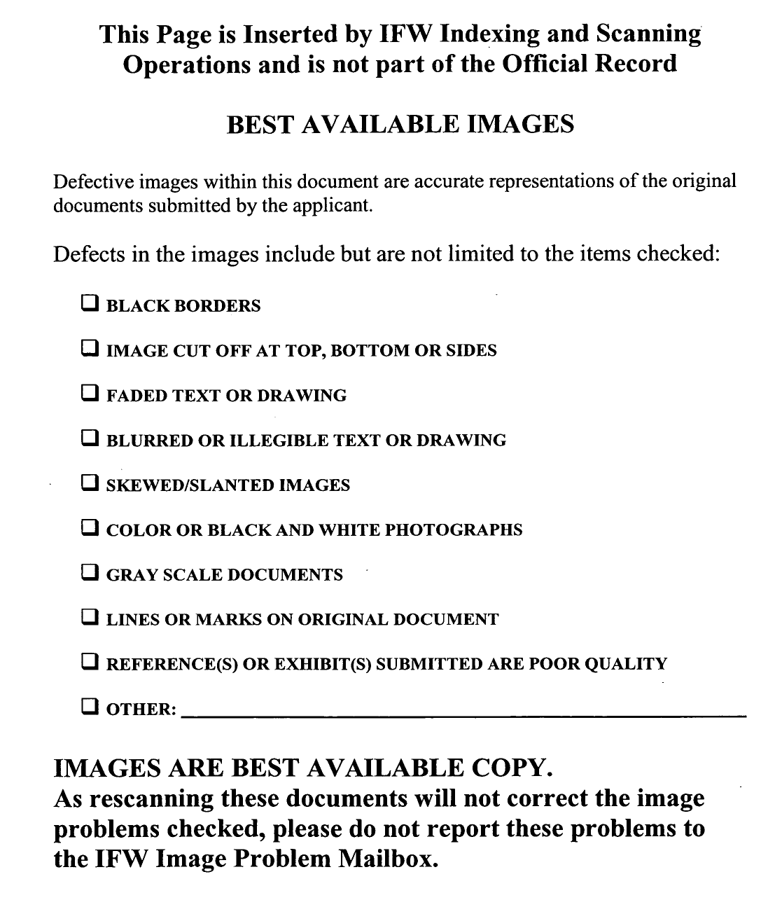

FIG. 12 shows the average loss ratio versus bandwidth overhead of these three schemes. It can be observed that the two NEF schemes can achieve less average loss ratio with less bandwidth overhead than that of end-to-end FEC. For certain range of overhead (less than 0.07), the distributed process outperforms the centralized process, this is because in the centralized process, codecs always use the same code rate as the one used by the source node, while in the distributed process, codecs use adaptive code rate.

In summary of the distributed codec placement process, in this disclosure, a distributed codec placement process for NEF was designed and implemented. The simulation shows that the distributed process can cope with the network dynamics very well. The bandwidth overhead of the centralized and the distributed NEF was compared with that of the end-to-end FEC, and it was demonstrated that, to achieve the same loss rate, the NEF approach results in less bandwidth overhead than end-to-end FEC.

The description is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A multicast packet video system having machine instructions stored in a computer readable medium, the system comprising:
a codec placement module placing codecs in nodes of a multicasting network, said module including at least one of:
(a) distributed codec placement machine instructions receiving, at a parent node of the network, feedback from its child nodes indicating a number of the child nodes unable to decode FEC blocks, and placing a codec at the parent node if the number exceeds a threshold; or
(b) centralized codec placement machine instructions placing codecs in nodes of a multicasting tree of the network by recursively performing a search of a network topology T to find an optimum node c at which to place a codec in order to obtain a maximum improvement in average video-packet throughput over nodes of the tree as a result of the codec recovering lost video and parity packets and transmitting them downstream.

2. The system of claim 1, wherein said codec placement module places codecs in nodes of the multicasting network by receiving, at the parent node of the network, feedback from its child nodes indicating the number of the child nodes unable to decode FEC blocks, and places the codec at the parent node if the number exceeds the threshold.

3. The system of claim 2, wherein a node of the network keeps a first record of a largest number of parity packets required by the node itself and its immediate children, and a second record of a total number of nodes in a subtree rooted at the node (including itself) that, on average, can not decode FEC blocks if they do not receive parity packets produced by an immediate codec upstream.

4. The system of claim 3, wherein the first record and the second record are updated by the node when it receives feedback from its children, and the node sends feedback to its parent periodically, thereby ensuring that, as information is passed from leaf nodes toward a root of the multicast tree, each node in the multicast stream eventually knows the largest number of parity packets required among the nodes that belong to a subtree rooted at that node, and each node also knows a total number of nodes in its subtree that, on average, can not decode FEC blocks if they do not receive extra parity packets from the immediate codec upstream of that node.

5. The system of claim 2, wherein, in order for a node to act as a codec, it is required that:
on average, the node must be able to decode FEC blocks successfully; and
a number of children of the node that require extra parity packets must exceed the threshold.

6. The system of claim 2, wherein a node has a data structure storing information associated with each of its immediate children, including a first data member indicating the parity packets required by the child from its immediate codec upstream, and a second data member indicating a number of child nodes in the sub-tree rooted at the node that, on average, can not decode FEC blocks if it does not receive parity packets produced by an immediate codec upstream, the immediate codec upstream being a closest codec to the child node on a path that leads the child node to a source.

7. The system of claim 2, wherein a node keeps a record of each codec upstream from the node, and, when the node receives a parity packet produced by the codec, it records its IP address and a hop-count from the codec to itself so that the node can tell which codec is its immediate codec upstream.

8. The system of claim 2, wherein a node keeps an estimate of its average received packets per FEC block.

9. The system of claim 2, wherein a node keeps an estimate of its average received packets per FEC block without counting any parity packets it receives from its immediate codec upstream.

10. The system of claim 1, further comprising:
a topology datastore storing a datastructure representing the given network topology T of a multicasting network, wherein said codec placement module accesses said topology datastore and places codecs in nodes of the multicasting tree of the network by recursively performing the search of the network topology T to find an optimum node c at which to place the codec in order to obtain the maximum improvement in average video-packet throughput over nodes of the tree as the result of the codec recovering lost video and parity packets and transmitting them downstream.

11. The system of claim 10, wherein said codec placement module places codecs until a quality of service guarantee requirement is met.

12. The system of claim 11, wherein said network is a p2p network, and said codec placement module averages throughput over all nodes of the tree.

13. The system of claim 11, wherein said network is a proxy-based, overlay network, and said codec placement module averages throughput over only leaf nodes of the tree.

14. The system of claim 11, wherein said codec placement module places FEC codecs.

15. A network router, comprising:
an input receptive of a multicasting stream from upstream;
a plurality of outputs transmitting the multicasting stream downstream;
a routing table adapted to rout the multicasting stream downstream via said outputs; and
an FEC codec recovering lost video and parity packets and transmitting them downstream,
wherein a position of said codec in a multicasting tree of a network is at least one of:
(a) dynamically determined in response to feedback at a node that is the router from its child nodes indicating a number of the child nodes unable to decode FEC blocks; or
(b) an optimal position, in view of a topology of the network, at which to place the FEC codec in order to maximize average video-packet throughput over nodes of a multicasting tree of the network.

16. The router of claim 15, further comprising a codec placement module placing the codec at the node in response to the feedback from its child nodes if the number of its child nodes unable to decode FEC blocks exceeds a threshold.

17. The router of claim 16, further comprising a data structure storing information associated with each of the node's immediate children, including a first data member indicating the parity packets required by the child from the child's respective immediate codec upstream, and a second data member indicating a number of child nodes in the sub-tree rooted at the node that, on average, can not decode FEC blocks if they do not receive parity packets produced by their immediate codecs upstream, wherein a particular node's immediate codec upstream is a closest codec to the particular node on a path that connects the particular node to a multicasting source.

18. The router of claim 16, wherein the rnode keeps a record of each codec upstream from the node, and, when the node receives a parity packet produced by a codec, it records the codec's IP address and a hop-count from the codec to itself so that the node can tell which codec is its immediate codec.

19. The router of claim 16, wherein the node keeps an estimate of its average received packets per FEC block.

20. The router of claim 16, wherein the node keeps an estimate of its average received packets per FEC block without counting any parity packets it receives from its immediate codec upstream.

21. The router of claim 16, wherein the node keeps a first record of a largest number of parity packets required by the node itself and its immediate children, and a second record of a total number of nodes in a subtree rooted at the node, including itself, that, on average, can not decode FEC blocks if they do not receive parity packets produced by their respective immediate codecs upstream.

22. The router of claim 15, further comprising:
a topology datastore storing a datastructure representing the given network topology T of a multicasting network, wherein said codec placement module accesses said topology datastore and places codecs in nodes of the multicasting tree of the network by recursively performing the search of the network topology T to find an optimum node c at which to place the codec in order to obtain the maximum improvement in average video-packet throughput over nodes of the tree as the result of the codec recovering lost video and parity packets and transmitting them downstream.

23. The router of claim 22, wherein said network is a p2p network, and said average-video packet throughput is averaged over all nodes of the tree.

24. The router of claim 22, wherein said network is a proxy-based, overlay network, and said average-video packet throughput is averaged over only leaf nodes of the tree.

25. A codec placement method for use with a multicast packet video system, the method comprising:
placing codecs in nodes of a multicasting network by at least one of:
(a) receiving, at a parent node of the network, feedback from its child nodes indicating a number of the child nodes unable to decode FEC blocks, and placing a codec at the parent node if the number exceeds a threshold; or
(b) placing codecs in nodes of a multicasting tree of the network by recursively performing a search of a network topology to find an optimum node c at which to place a codec in order to obtain a maximum improvement in average video-packet throughput over nodes of the tree as a result of the codec recovering lost video and parity packets and transmitting them downstream.

26. The method of claim 25, wherein placing codecs in nodes of the multicasting network includes receiving, at the parent node of the network, feedback from its child nodes indicating the number of the child nodes unable to decode FEC blocks, and placing the codec at the parent node if the number exceeds the threshold.

27. The method of claim 26, further comprising requiring that, in order for a node to act as a codec:
on average, the node must be able to decode FEC blocks successfully; and
a number of children of the node that require extra parity packets must exceed the threshold.

28. The method of claim 26, further comprising recording at a node information associated with each of its immediate children, including a first data member indicating the parity packets required by each child from the child's respective immediate codec upstream, and a second data member indicating a number of child nodes in the sub-tree rooted at the node i that, on average, can not decode FEC blocks if they do not receive parity packets produced by their respective immediate codecs upstream, wherein a particular node's immediate codec upstream is a closest codec to the particular node on a path that connects the particular node to a multicasting source.

29. The method of claim 26, further comprising recording at a node information concerning each codec upstream from the node, and, when the node receives a parity packet produced by a codec, recording the codec's IP address and a hop-count from the codec to itself so that the node can tell which codec is its immediate codec.

30. The method of claim 26, further comprising estimating at a node its average received packets per FEC block.

31. The method of claim 26, further comprising estimating at a node its average received packets per FEC block without counting any parity packets it receives from its immediate codec upstream.

32. The method of claim 26, further comprising recording at a node a first record of a largest number of parity packets required by the node itself and its immediate children, and a second record of a total number of nodes in a subtree rooted at the node, including itself, that, on average, can not decode FEC blocks if they do not receive parity packets produced by their respective immediate codecs upstream.

33. The method of claim 32, further comprising:
updating the first record and the second record when the node receives feedback from its children; and
sending feedback from the node to its parent periodically, thereby ensuring that, as information is passed from leaf nodes toward a root of the multicast tree, each node eventually knows the largest number of parity packets required among the nodes that belong to a subtree rooted at that node, and each node also knows a total number of nodes in its subtree that, on average, can not decode FEC blocks if they do not receive extra parity packets from their respective immediate codecs upstream.

34. The method of claim 25, wherein placing the codecs includes placing NEF codecs within a given network topology T.

35. The method of claim 34, further comprising employing a greedy calculation to place m codecs in a multicast tree for the network topology T, including:
(a) performing an exhaustive search of the network topology T to find an optimum node c at which to place a codec in order to obtain a maximum improvement in average video-packet throughput over nodes of the tree as a result of the codec recovering lost video and parity packets and transmitting them downstream;
(b) placing the codec at the optimum node c in the network topology T;
(c) performing steps (b) and (c) respective of the network topology T containing the codec placed in the network topology T during previous performance of step (b); and
(d) iteratively performing step (c) respective of the network topology T containing all codecs placed in the network topology T during previous performance of step (b) until all m codecs are placed in the network topology T.

36. The method of claim 35, further comprising determining a number of codecs m based on required quality of service guarantees.

37. The method of claim 36, wherein determining m includes in step (c):
averaging distortion level over all nodes, thereby obtaining an average distortion level;
comparing the average distortion level to a lossless distortion level, thereby calculating a quality of service measure obtainable with a current value of m;
observing a termination condition based on a comparison of the quality of service measure to the required quality of service guarantees; and
incrementing m if the termination condition is not satisfied.

38. The method of claim 35, wherein the network topology T is for a p2p multicast network, and step (a) includes identifying the optimum node c by finding c∈T that maximizes the following:
$${max}_{c ∈ T} [ {\sum }_{v ∈ {T}^{c}} ( {E}^{′} [ {r}_{d} ( v ) ] - E [ {r}_{d} ( v ) ] ) ] ,$$
wherein E[r_{d}(v)] and E′[r_{d}(v)] denote average received packets for node v∈T^{c} before and after node c is set as a codec node, respectively, and T^{c}⊂T is a sub tree rooted at node c∈T, not including c.

39. The method of claim 35, wherein the network topology T is for a proxy-based, overlay multicast network, and step (a) includes identifying the optimum node c by finding c∈T that maximizes a function similar to the following:
$${max}_{c ∈ T} [ {\sum }_{v ∈ {T}^{c}} ( {E}^{′} [ {r}_{d} ( v ) ] - E [ {r}_{d} ( v ) ] ) ] ,$$
wherein E[r_{d}(v)] and E′[r_{d}(v)] denote average received packets for node v∈T^{c} before and after node c is set as a codec node, respectively, and T^{c}⊂T is a sub tree rooted at node c∈T, not including c, and the function differs in that the summation only occurs over leaf nodes of the network topology T.

40. The method of claim 35, further comprising placing NEF codecs in step (b).

41. A multicast network, comprising:
a plurality of network nodes; and
an FEC codec at one of said nodes recovering lost video and parity packets, and transmitting the lost video and parity packets downstream,
wherein a position of said codec in a multicasting tree of the network is at least one of:
(a) dynamically determined in response to feedback at a node of the network from its child nodes indicating a number of the child nodes unable to decode FEC blocks; or
(b) an optimal position, in view of a topology of the network, at which to place the FEC codec in order to maximize average video-packet throughput over nodes of a multicasting tree of the network.

42. The network of claim 41, further comprising a codec placement module placing the codec at the node of the network in response to the feedback from its child nodes if the number of its child nodes unable to decode FEC blocks exceeds a threshold.

43. The network of claim 42, further comprising a data structure storing information associated with each of the node's immediate children, including a first data member indicating the parity packets required by a child from the child's respective immediate codec upstream, and a second data member indicating a number of child nodes in the sub-tree rooted at the node that, on average, can not decode FEC blocks if they do not receive parity packets produced by their immediate codecs upstream, wherein a particular node's immediate codec upstream is a closest codec to the particular node on a path that connects the particular node to a multicasting source.

44. The network of claim 42, wherein the node keeps a record of each codec upstream from the node, and, when the node receives a parity packet produced by a codec, it records the codec's IP address and a hop-count from the codec to itself so that the node can tell which codec is its immediate codec.

45. The network of claim 42, wherein the node keeps an estimate of its average received packets per FEC block.

46. The network of claim 42, wherein the node keeps an estimate of its average received packets per FEC block without counting any parity packets it receives from its immediate codec upstream.

47. The network of claim 42, wherein the node keeps a first record of a largest number of parity packets required by the node itself and its immediate children, and a second record of a total number of nodes in a subtree rooted at the node, including itself, that, on average, can not decode FEC blocks if they do not receive parity packets produced by their respective immediate codecs upstream.

48. The network of claim 41, further comprising:
a first NEF codec placed at a first selected node of said multicast tree, said first selected node being selected to obtain a maximum improvement in average video-packet throughput over nodes of said tree as a result of said first NEF codec recovering lost video and parity packets and transmitting them downstream.

49. The network of claim 48, further comprising a second NEF codec placed at a second selected node of said multicast tree, said first selected node being selected to obtain a maximum improvement in average video-packet throughput over nodes of said tree as a result of said first NEF codec and said second NEF codec recovering lost video and parity packets and transmitting them downstream.

50. The network of claim 49, further comprising a third NEF codec placed at a third selected node of said multicast tree, said third selected node being selected to obtain a maximum improvement in average video-packet throughput over nodes of said tree as a result of said first NEF codec, said second NEF codec, and said third NEF codec recovering lost video and parity packets and transmitting them downstream.

51. The network of claim 48, further comprising m−1 additional NEF codecs placed at m−1 selected nodes of said tree, each of said m−1 selected nodes being selected one by one to obtain a maximum improvement in average video-packet throughput over nodes of said tree as a result of one by one placement of said additional NEF codecs at said m−1 selected nodes, said maximum improvement in average video packet throughput being evaluated after placement of each of the m−1 additional NEF codecs based on the first node and all additional nodes thus far placed in the tree recovering lost video and parity packets and transmitting them downstream, wherein m is determined based on achievement of a target average throughput over nodes of the tree.

52. The network of claim 48, wherein said network is a p2p network, and the throughput is averaged over all nodes of the tree.

53. The network of claim 48, wherein said network is a proxy-based, overlay network, and the throughput is averaged over only leaf nodes of the tree.

54. Computer software, stored in a computer readable storage medium, for placing codecs in nodes of a multicast tree of a network, comprising:
first machine instructions receiving, at a parent node of the network, feedback from its child nodes indicating a number of the child nodes unable to decode FEC blocks; and
second machine instructions placing a codec at the parent node if the number exceeds a threshold.

55. The software of claim 54, further comprising third machine instruction requiring that, in order for a node to act as a codec:
on average, the node must be able to decode FEC blocks successfully; and
a number of children of the node that require extra parity packets must exceed the threshold.

56. The software of claim 54, further comprising third machine instruction recording at a node information associated with each of its immediate children, including a first data member indicating the parity packets required by each child from the child's respective immediate codec upstream, and a second data member indicating a number of child nodes in the sub-tree rooted at the node i that, on average, can not decode FEC blocks if they do not receive parity packets produced by their respective immediate codecs upstream, wherein a particular node's immediate codec upstream is a closest codec to the particular node on a path that connects the particular node to a multicasting source.

57. The software of claim 54, further comprising third machine instruction recording at a node information concerning each codec upstream from the node, and, when the node receives a parity packet produced by a codec, recording the codec's IP address and a hop-count from the codec to itself so that the node can tell which codec is its immediate codec.

58. The software of claim 54, further comprising third machine instruction estimating at a node its average received packets per FEC block.

59. The software of claim 54, further comprising third machine instruction estimating at a node its average received packets per FEC block without counting any parity packets it receives from its immediate codec upstream.

60. The software of claim 54, further comprising third machine instruction recording at a node a first record of a largest number of parity packets required by the node itself and its immediate children, and a second record of a total number of nodes in a subtree rooted at the node, including itself, that, on average, can not decode FEC blocks if they do not receive parity packets produced by their respective immediate codecs upstream.

61. The software of claim 60, further comprising fourth machine instruction updating the first record and the second record when the node receives feedback from its children, and sending feedback from the node to its parent periodically, thereby ensuring that, as information is passed from leaf nodes toward a root of the multicast tree, each node eventually knows the largest number of parity packets required among the nodes that belong to a subtree rooted at that node, and each node also knows a total number of nodes in its subtree that, on average, can not decode FEC blocks if they do not receive extra parity packets from their respective immediate codecs upstream.

62. Computer software, stored in a computer readable storage medium, for placing codecs in nodes of a multicast tree of a network, comprising:
first machine instructions performing an exhaustive search of a network topology T to find an optimum node c at which to place a codec in order to obtain a maximum improvement in average video-packet throughput over nodes of the tree as a result of the codec recovering lost video and parity packets and transmitting them downstream;
second machine instructions placing the codec at the optimum node c in the network topology T;
third machine instructions iteratively performing said first machine instructions and said second machine instructions respective of the network topology T containing the codec placed in the network topology T during previous performance of said second machine instructions; and
fourth machine instructions iteratively performing said third machine instructions respective of the network topology T containing all codecs placed in the network topology T during previous performance of said second machine instructions until a number of codecs m are placed in the network topology T.

63. The software of claim 62, further comprising fifth machine instructions determining the number of codecs m based on required quality of service guarantees.

64. The software of claim 63, wherein said fifth machine instructions include:
a first machine instruction component that averages distortion level over all nodes, thereby obtaining an average distortion level;
a second machine instruction component that compares the average distortion level to a lossless distortion level, thereby calculating a quality of service measure obtainable with a current value of m;
a third machine instruction component that observes a termination condition based on a comparison of the quality of service measure to the required quality of service guarantees; and
a fourth machine instruction component that increments m if the termination condition is not satisfied.

65. The software of claim 62, wherein the network topology T is for a p2p multicast network, and said first machine instructions identify the optimum node c by averaging throughput over all nodes of the tree.

66. The software of claim 65, wherein said first machine instructions identify the optimum node c by finding c∈T that maximizes the following expression:
$${max}_{c ∈ T} [ {\sum }_{v ∈ {T}^{c}} ( {E}^{′} [ {r}_{d} ( v ) ] - E [ {r}_{d} ( v ) ] ) ] ,$$
wherein E[r_{d}(v)] and E′[r_{d}(v)] denote average received packets for node v∈T^{c} before and after node c is set as a codec node, respectively, and T^{c}⊂T is a sub tree rooted at node c∈T, not including c.

67. The software of claim 62, wherein the network topology T is for a proxy-based, overlay multicast network, and said first machine instructions identify the optimum node c by averaging throughput over only leaf nodes of the tree.

68. The software of claim 67, wherein said first machine instructions identify the optimum node c by finding c∈T that maximizes a function similar to the following:
$${max}_{c ∈ T} [ {\sum }_{v ∈ {T}^{c}} ( {E}^{′} [ {r}_{d} ( v ) ] - E [ {r}_{d} ( v ) ] ) ] ,$$
wherein E[r_{d}(v)] and E′[r_{d}(v)] denote average received packets for node v∈T^{c} before and after node c is set as a codec node, respectively, and T^{c}⊂T is a sub tree rooted at node c∈T, not including c, and the function differs in that the summation only occurs over leaf nodes of the network topology T.

69. The software of claim 62, wherein said second machine instructions place NEF codecs.
